(19) United States
(12) Patent Application Publication
(10) Pub. No.: US 2026/0010923 A1
(43) Pub. Date: Jan. 8, 2026

(54) SYSTEMS AND METHODS FOR AUTOMATED ENGAGEMENT VIA ARTIFICIAL INTELLIGENC

(71) Applicant: Generus, Cambridge, MA (US)

(72) Inventors: Jamie Larsen, Cambridge, MA (US); Frank Tino, Cambridge, MA (US); Abdulrahman Shamsan, Cambridge, MA (US); Leslie Graff, Cambridge, MA (US); Bryan Saxon, Cambridge, MA (US)

(73) Assignee: Generus, Cambridge, MA (US)

(21) Appl. No.: 18/994,202

(22) PCT Filed: Jul. 17, 2023
(86) PCT No.: PCT/US2023/027921

§ 371 Date: Jan. 14, 2025

Related U.S. Application Data
(60) Provisional application No. 63/368,546, filed on Jul. 15, 2022.

(51) Int. Cl. G06Q 30/0203; G06F 16/31; G06F 16/35; G06F 40/284; G06F 40/30; G06F 40/40

(52) U.S. Cl. CPC G06Q 30/0203; G06F 16/313; G06F 16/35; G06F 40/284; G06F 40/30; G06F 40/40

(57) ABSTRACT

An emerging service in the private and non-profit sectors is to electronically facilitate engagement of employees and volunteers for various causes. The instant systems and methods provide a software as a service platform that provides user engagement via machine learning and artificial intelligence.

### CROSS-REFERENCE TO RELATED APPLICATION

This Application claims the benefit of U.S. Provisional Application Ser. No. U.S. 63/368,546, filed Jul. 15, 2022, which is incorporated herein by reference in its entirety.

### TECHNICAL FIELD

The present disclosure generally relates to novel systems and methods for a software as a service platform that provides user engagement via machine learning and artificial intelligence.

### BACKGROUND

Corporate, non-profit, and philanthropic entities often utilize their organizational resources to further certain initiatives, such as organizing volunteers, hosting volunteering events, and generating engagement for causes. Historically, many of the tasks associated with implementing such initiatives require manual processes for data gathering and for potential volunteers to seek volunteering opportunities through their own efforts. Volunteering events have historically been done in person, where employer-sponsored events require significant time commitment by employees, often requiring them to leave work for an entire day, travel to a local area and spend a few hours on a project. This solution is particularly inefficient for companies using distributed work forces, as time and budgetary constraints usually prohibit gathering people from different offices for volunteering events. Conventional approaches to improving volunteering initiatives are still rudimentary in nature, and include technical solutions such as, web pages that provide the details of volunteering opportunities, telephonic modes that utilize online directories to organize volunteers, and grass roots outreach modes. These systems can help facilitate basic connections between charities and potential volunteers but are not adapted to drive participation in events or engagement more generally within an employee base, nor are they configured to provide electronic event programming that can be accessed by multiple users and adapted in real-time. Developing content for an engagement event, whether volunteering or otherwise, that can appeal to a large number of participants is generally difficult, made more so by remote work arrangements. But remote working has established itself as a permanent part of the economy, particularly since the COVID-19 pandemic. Meeting the needs of remote employees for engagement and team building is a particular challenge. Accordingly, there is a need for improved systems and methods that overcome the aforementioned challenges.

### BRIEF DESCRIPTION OF THE FIGURES

FIG. 1 illustrates a computing environment, according to various embodiments of the present disclosure.

FIG. 2 illustrates an artificial intelligence engagement framework, according to various embodiments of the present disclosure.

FIG. 3 illustrates a method for recommending an engagement opportunity, according to various embodiments of the present disclosure.

FIG. 4 illustrates an interactive graphical user interface, according to various embodiments of the present disclosure.

FIG. 5 illustrates a block diagram for a computing device, according to various embodiments of the present disclosure.

### SUMMARY

Embodiments of the present disclosure relate to systems and methods for automated development of content for engagement events to be delivered to users, such as employees in a distributed work environment. Engagement can be done via artificial intelligence configured to analyze sentiment, semantics, infer behavior, and further rank and classify users and data associated with virtual events. In some applications, the embodiments present a real-time technical means of identifying and assembling content of interest to the users (e.g., humorous content) that can be used to engage the group in a virtual event. The implementation of these novel concepts may include, in one respect, receiving one or more electronic user responses corresponding to one or more users wherein the one or more user responses are associated with an electronic survey. In implementations, the survey includes a first set of questions and a second set of questions included in one or more surveys. The implementation may further include classifying the one or more users into a first group based on the user responses to the first set of questions and classifying the one or more users into a sub-group of the first group based on the user responses to the second set of questions. Further, the implementation may include recommending an engagement opportunity to each of the one or more users based on the sub-group associated with each of the one or more users. The implementation further includes, designing and initiating the engagement opportunity, wherein the content presented in the engagement opportunity is customized based on the survey responses. For example, the content may be generated based on the sub-group. A server system may input user event responses into a natural language processing model, wherein the user event responses are ranked and used to modify the content presented in the engagement opportunity. Next the server system may receive feedback from the one or more users and fine-tune the natural language processing model based on the feedback from the one or more users.

In particular, the instant systems and methods provide novel techniques for overcoming the deficiencies of conventional systems by leveraging artificial intelligence and machine learning to analyze user responses (e.g., responses to one or more surveys) in order to generate engagement event opportunity recommendations and custom content for the user during the engagement event. Further, the instant systems and methods may provide novel techniques for authentically generating positive psychological experiences to build relationships and create transference to an employer.

In various implementations, systems, methods, and computer readable medium are disclosed herein. In some embodiments, a system is disclosed having a server comprising one or more processors; and a non-transitory memory, in communication with the server, storing instructions that when executed by the one or more processors, causes the one or more processors to implement methods for developing and implementing one or more engagement events. In some implementations, the methods comprise steps of receiving by an electronic interface one or more user responses corresponding to one or more users, wherein the one or more user responses are associated with a first set of questions and a second set of questions included in one or more surveys; classifying the one or more users into a first group based on the user responses to the first set of questions; classifying the one or more users into a second group based on the user responses to the second set of questions; and storing an association between the second group and a plurality of engagement opportunities in an electronic database, wherein the plurality of engagement opportunities are each configured to present electronic content.

The method may further include selecting an engagement opportunity from the plurality of engagement opportunities based on the second group and electronically recommending the selected engagement opportunity to each of the one or more users. After recommendation of an event, the initiating the selected engagement opportunity through one or more electronic interfaces, wherein electronic content presented in the engagement opportunity is generated based on the second group. The method may further include receiving user event responses electronically during the engagement opportunity; inputting the received user event responses into a natural language processing model, wherein the user event responses are ranked and used to modify the content presented in the engagement opportunity; receiving feedback from the one or more users; and training the natural language processing model based on the feedback from the one or more users.

In some embodiments, a computer-implemented method is disclosed for identifying an engagement event that would be applicable, or of particular interest, to a group or subgroup of an organization. In some embodiments, a non-transitory computer-readable medium is provided, storing instructions, that when executed by one or more processors, cause the one or more processors to implement the instructions for electronic methods for one or more of identifying an engagement event that would be applicable, or of particular interest, to a group or subgroup of an organization, configuring such event, and implementing it.

Applications of the methods include implementing steps of receiving one or more user responses corresponding to one or more users, wherein the one or more user responses are associated with a first set of questions and a second set of questions included in one or more surveys; classifying the one or more users into a first group based on the user responses to the first set of questions; classifying the one or more users into a sub-group of the first group based on the user responses to the second set of questions; recommending the engagement opportunity to each of the one or more users based on the sub-group associated with each of the one or more users. The recommended event could then be initiated, wherein content presented in the engagement opportunity is generated based on the sub-group or based on the results of the electronic survey. In some applications, the generated content is accessed in a preconfigured database, having pre-arranged content that is sortable and accessible according to codes that are determined based on the subgroup or based on the survey results. In applications, user event responses are inputted into a natural language processing model, wherein the user event responses are ranked and used to modify the content presented in the engagement opportunity. User feedback may be obtained electronically (e.g., in a post-event survey, or by detecting one or more user actions or indications during the event) and used to train the natural language processing (or other artificial intelligence) model.

In further adaptations, the implemented methods of the systems comprise tokenizing the user responses and determining an importance of each word or phrase in the response using a term frequency inverse document frequency model. A machine learning model may further classify the user event responses. The method may further include identifying engagement opportunities (such as by an electronically generated signal from a computer) to users based on the second group the one or more users are assigned to and may include steps of determining user sentiment in real-time and responsively generating new content for the engagement opportunity. Training the natural language processing model based on the feedback from the one or more users may further comprise fine tuning and updating pre-trained weights of the natural language processing model. Performance of a machine learning model related to properly classifying the one or more user responses may be evaluated using exact match.

Delivery of virtual engagement events to diverse and often distributed work forces can be particularly challenging and time consuming. The methods and systems disclosed herein can be adapted for providing a technology solution to that problem. In some embodiments, a computer-implemented method for preparing and delivering a customized virtual engagement event to a plurality of participants is provided. The method may include steps of receiving electronic responses corresponding to a plurality of prospective virtual event participants, wherein the electronic responses are associated with a set of questions included in the one or more electronic surveys sent to said plurality participants. The electronic responses from the plurality of participants are inputted as first input data into an artificial intelligence model, wherein the first input data responsively causes the artificial intelligence model to produce electronic content, customized according to the electronic responses, for the customized virtual engagement event. The artificial intelligence models used herein may be configured with one or more functionalities that produce an assessment of the responses based on, for each response, one or more of an indication of sentiment in the response, character or word length of the response, patterns in the terms (words or phrases) in the response, such as uniqueness of word choice in the response, complexity of sentence or phrase structure in the response, or other characteristic indicated by or in the response.

The computer implementation of engagement events (e.g., a virtual game, volunteering event, or combination) may be done by integrating and applying the customized electronic content. The customized electronic content may be assembled or selected based on the assessment. For example, the received responses may be ranked according to the respective assessment of the responses. The customized content may be selected so as to appeal to the plurality of participants based on the ranking. In some applications the appeal of humor can be designed into a game or other event, with the assessment identifying terms from the survey with a high likelihood of providing a level of expected humor or other specific interest of the plurality of participants.

The engagement event can be delivered electronically to the plurality of participants over one or more computer interfaces. During the event, real-time feedback can be received and evaluated, such as sentiment data indicative of sentiment of the plurality of participants during the event. The sentiment data can be indicative of sentiment expressed by the plurality of participants in response to the customized content. In some applications, the engagement event includes a virtual game, that is customized according to the received responses (e.g., by extracting one or more terms or phrases from the survey responses, based on the assessment, and integrating such terms or phrases into the game, configured in software for delivery as remote content to the participants in the event). In some applications, the event (e.g., the virtual game) includes a quotation or summary from one or more of the received responses. Inputs indicative of a winner of the virtual game may also be received electronically and displayed to the participants in the event, and inputs indicative of user sentiment expressed in response to identification of a winner of the game may also be received.

Sentiment of users participating in the event can be identified and their individual responses ranked based on a sentiment score and weighted majority rule ensemble classifier. Performance of the artificial intelligence models may be done using k-fold cross validation.

The engagement event may include one or more of an educational component about a charity or other public cause, and a hands-on craft or other activity to be performed by individuals of the plurality of participants during the engagement event. The user sentiment assessments may also be done by receiving inputs indicative of user sentiment expressed in response to the one or more of educational component and hands-on craft or other activity, and feedback from one or more of the plurality of participants after the engagement event.

User sentiment and other feedback information received as a result of the survey, during the event, or post-event evaluations are collected and inputted into the artificial intelligence model to further train and enhance the model.

Applications and other embodiments further include those set forth in the claims.

### DETAILED DESCRIPTION

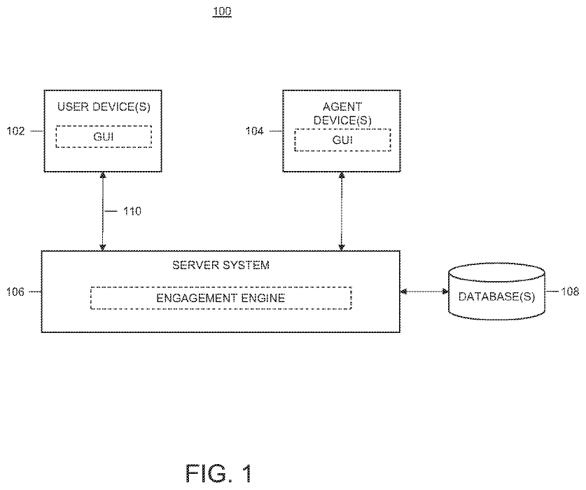

Referring to FIG. 1, according to embodiments of the present disclosure, computing environment 100 may facilitate generating engagement opportunity recommendations from user responses inputted via interactive GUI operating on a user device, classifying users into in one or more groups and sub-groups, ranking the user responses via artificial intelligence to provide customized content during the engagement opportunity.

Computing environment 100 may include one or more end user device(s) 102, one or more agent device(s) 104, a server system 106, and a database 108 communicatively coupled to the server system 106. End user device(s) 102, agent device(s) 104, server system 106, and database(s) 108, that are configured to communicate through network 110.

In one or more embodiments, each end user device(s) 102 is operated by a user. End user device(s) 102 may be representative of a mobile device, a tablet, a desktop computer, or any computing system having the capabilities described herein. Users may include, but are not limited to, individuals such as, for example, users, subscribers, customers, clients, employees of clients, or prospective clients, of an entity associated with server system 106, such as individuals who have obtained, will obtain, or may obtain a product, service, or consultation from an entity associated with server system 106.

End user device(s) 102 according to the present disclosure include, without limit, any combination of mobile phones, smart phones, tablet computers, laptop computers, desktop computers, server computers or any other computing device configured to capture, receive, store and/or disseminate any suitable data. In one embodiment, end user device(s) 102 includes a non-transitory memory, one or more processors including machine readable instructions, a communications interface that may be used to communicate with the server system (and, in some examples, with the database(s) 108, a user input interface for inputting data and/or information to the user device and/or a user display interface for presenting data and/or information on the user device. In some examples, the user input interface and the user display interface are configured as an interactive graphical user interface (GUI) associated with a platform. End user device(s) 102 are also configured to provide the server system 106, via the interactive GUI, with input information (e.g., user preferences from interacting with one or more products or services) for further processing. In some examples, the interactive GUI may be hosted by the server system 106 or it may be provided via a client application operating on the user device.

In one or more embodiments, each agent device(s) 104 is operated by a user partnering or has a professional relationship with the entity hosting and/or managing server system 106. Agent device(s) 104 may be representative of a mobile device, a tablet, a desktop computer, or any computing system having the capabilities described herein. Users of the agent device(s) 104 include, but are not limited to, individuals such as, for example, software engineers, database administrators, and/or employees, associated with server system 106.

Agent device(s) 104 according to the present disclosure include, without limit, any combination of mobile phones, smart phones, tablet computers, laptop computers, desktop computers, server computers or any other computing device configured to capture, receive, store and/or disseminate any suitable data. In one embodiment, each agent device(s) 104 includes a non-transitory memory, one or more processors including machine readable instructions, a communications interface that may be used to communicate with the server system (and, in some examples, with the database(s) 108, a user input interface for inputting data and/or information to the user device and/or a user display interface for presenting data and/or information on the user device. In some examples, the user input interface and the user display interface are configured as an interactive GUI. The agent device(s) 104 are also configured to provide the server system 106, via the interactive GUI, input information (e.g., survey information, human resource information, event content, organization information, software code and parameter information). In some examples, the interactive GUI may be hosted by the server system 106 or it may be provided via a client application operating on the agent device(s) 104.

The server system 106 includes one or more processors, servers, databases, communication/traffic routers, non-transitory memory, modules, and interface components. In one or more embodiments, server system 106 hosts, stores, and operates a match analytics engine and/or a machine learning model, to analyze user input data (e.g., user preferences, sentiment analysis, semantic analysis of user responses, user feedback etc.), classify and rank users or information associated with users, train an artificial intelligence and machine learning models, generate engagement event data/content and/or generate recommendations to users. Server system 106 may receive user input data associated with the one or more users, in response to an API call, a predetermined interface workflow, a user input query and/or in response to a series of prompts pushed to various computing devices in computing environment 100.

Moreover, the server system 106 may include security components capable of monitoring user rights and privileges associated with initiating API requests for accessing the server system 106 and modifying data in the database(s) 108. Accordingly, server system 106 may be configured to manage user rights, manage access permissions, object permissions, and the like. The server system 106 may be further configured to implement two-factor authentication, secure sockets layer (SSL) protocols for encrypted communication sessions, biometric authentication, and token-based authentication.

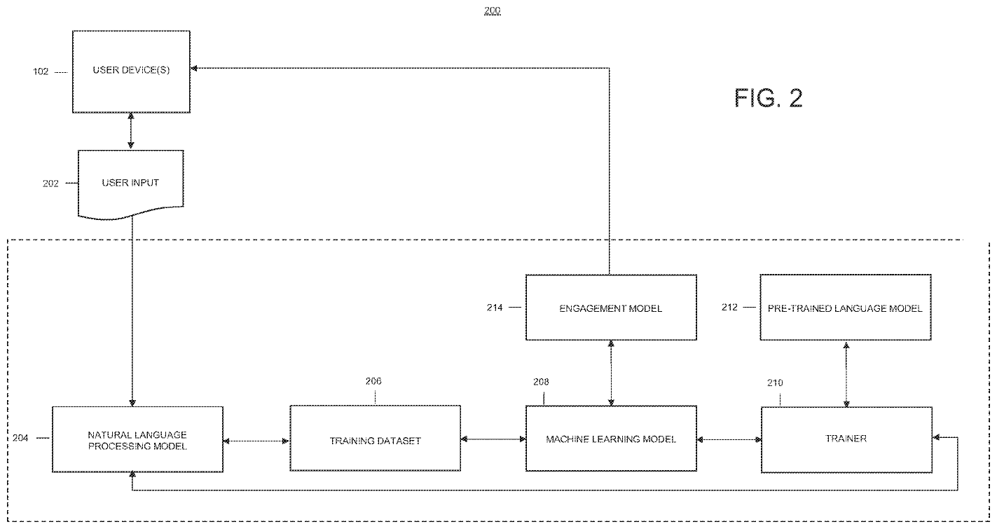

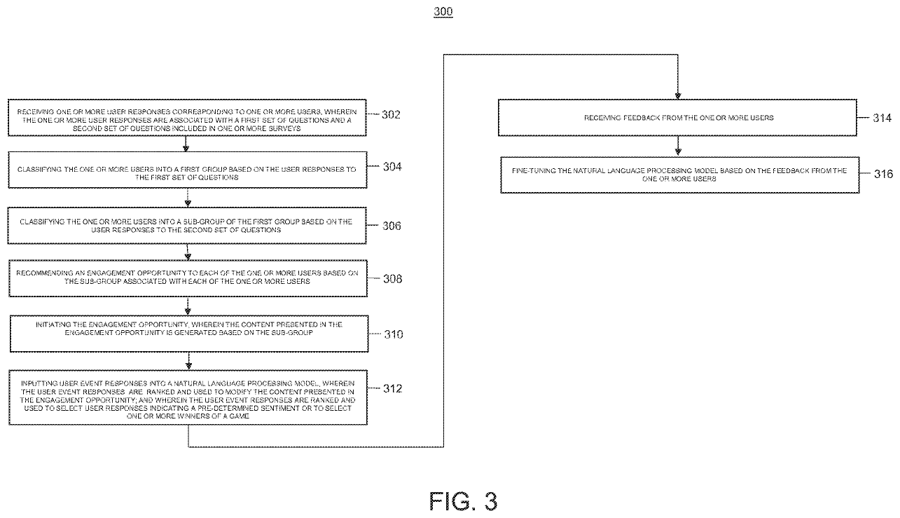

Database(s) 108 may be locally managed, or a cloud-based collection of organized data stored across one or more storage devices. Database(s) 108 may be complex and developed using one or more design schema and modeling techniques. Database(s) 108 may be hosted at one or more data centers operated by a cloud computing service provider. The database(s) 108 and may be geographically proximal to or remote from the server system 106 and configured for data dictionary management, data storage management, multi-user access control, data integrity, backup and recovery management, database access language application programming interface (API) management, and the like. The database(s) 108 and may be in communication with server system 106, end user device(s) 102, and agent device(s) 104, via network 110. Database(s) 108 stores various (encrypted) data, including user activity data, user preferences data, employee information, engagement event content, and artificial intelligence/machine learning training data that can be modified and leveraged by server system 106, end user device(s) 102, and agent device(s) 104. Various data in the database(s) 108 may be refined over time using a machine learning model artificial intelligence model, for example the machine learning model discussed with respect to FIGS. 2-3. Additionally, database(s) 108 may be deployed and maintained automatically by one or more components shown in FIG. 1.

Network 110 may be of any suitable type, including individual connections via the Internet, cellular or Wi-Fi networks. In some embodiments, network 110 may connect terminals, services, and mobile devices using direct connections, such as radio frequency identification (RFID), near-field communication (NFC), Bluetooth™, low-energy Bluetooth™ (BLE), Wi-Fi™, ambient backscatter communication (ABC) protocols, USB, WAN, LAN, or the Internet. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

In some embodiments, communication between the elements may be facilitated by one or more application programming interfaces (APIs). APIs of server system 106 may be proprietary and/or may be examples available to those of ordinary skill in the art such as Amazon® Web Services (AWS) APIs or the like.

Referring to FIG. 2, an artificial intelligence engagement framework 200 is depicted, according to various embodiments of the present disclosure. Framework 200 provides components and processes for evaluating users input (e.g., user responses to surveys) using natural language processing, performing domain specific feature engineering of document data, classifying and matching users into predetermined (or non-predetermined) groups, and automatically generating recommendations using natural language processing/machine learning. These features provide an improvement over the prior art which required manual human interpretation and human implemented processes for sentimentally and semantically analyzing user comments. As shown, artificial intelligence engagement framework 200 may include a natural language processing model component 204. Natural language processing model component 204 may be configured and capable of receiving a media file or text file (e.g., user input 202) and pre-processing the text in the text file to clean, remove, and/or extract predetermined objects, such as punctuation, extra white spaces, numbers, and the like. In one or more embodiments, natural language processing model component 204 is further configured to convert text into uppercase/lowercase text and tokenize the text. In one or more embodiments, natural language processing model component 204 is additionally configured to implement a language model configured for interpreting text from a user input (e.g., user responses received from a prompt on a platform, chat box, and/or survey) and producing word embeddings associated with the user input for downstream use.

Natural language processing model component 204 may be particularly configured for implementing one or more language models, such as term frequency inverse document frequency (TF-IDF), Bidirectional Encoder Representations from Transformers (BERT), Generative Pre-trained Transformer 2 (GPT2), Robustly Optimized BERT Pre-training Approach (ROBERTA), Word2Vec (the continuous bag-of-words model (CBOW) and the skip-gram model), and/or GloVe, BERT etc.), which may be utilized to convert words to a numerical value.

In one non-limiting example, the TF-IDF score is calculated as follows:

$$TF \times IDF$$

wherein TF(t)=(number of times term (or word) ‘t’ appears in a document) divided by the (total number of terms (or words) in the document); and IDF(t)=log (total number of documents) divided by the (number of documents with term (or word) ‘t’ in it).

The TF-IDF score provides an indication of how important each word is across the corpus. Here, the higher the TF-IDF score, the more significant and/or important the word is.

In one embodiment, the TF-IDF model computes a score for each word in the text file, thus approximating each word's importance. Then, each individual word score is used to compute a composite score for the text file by summing the individual scores of each word.

As shown, framework 200 includes a training dataset 206. Training dataset 206 is a corpus (or dictionary) comprised of numerous text and documents (e.g., user responses, client records, past/future engagement event data, survey text, and/or group/sub-group data) that may or may not have been previously run through the natural language processing model component 204 and machine learning model component 208.

In some embodiments, the natural language processing model component 204 and/or machine learning model component 208 may be trained on the training dataset 206. Here, training dataset 206 may be specifically cultivated to aid in the detection of user sentiment and emotion. Notably, conventional dictionaries often lack coverage of emerging new words and are typically based on static lexical resources that results in artificial intelligence and machine learning models generating less accurate predictions and classifications in domain specific use cases. In contrast, the instant dictionary includes a collection of words and phrases labeled for specific user sentiment (e.g., positive, negative, neutral) and emotion (e.g., humor, happiness, sadness, and the like) aggregated from previous user engagement events. During training, each word and phrase in the dictionary is assigned a sentiment score based on the following equation:

$$Sentiment score = \frac{\begin{matrix}Sum ( positive , intresting , and funny words ) - \\ Sum ( negitive words )\end{matrix}}{Total word count}$$

Although, funny words are highlighted in the sentiment score equation, this variable can be substituted for word count related to another type of sentiment. One or more phrases may also be used (e.g., funny phrases). Terms indicative of humor can be pre-identified as such (e.g., as funny words or phrases), and can be further characterized as “funny” based on sentiment reaction to the implementation of such terms in the engagement event. For example, terms in a survey response are identified by the model as being similar to pre-determined “funny” terms stored in an initial database, and therefore recommended for inclusion in customized content for the event. During the event, the sentiment of the participants to such terms is detected and evaluated, e.g., for smiles, laughter, or extensive chatting, and the response is ranked and compared to the initial “funny” characterization of such phrase. The terms may be included in the training database, identified as “funny” (or other characterization of humor) if its score reaches a pre-determined threshold. In addition to sentiment score, additional features such as, word count, char count, sentence count, average word length, average sentence length, Gunning fog index, Linsear write readability, juxtaposition of words, and difficult words (and other features), may be used to train the models.

Framework 200 may additionally include machine learning model component 208. In one or more embodiments, machine learning model component 208 is configured and/or capable of classifying user responses using a tree-based ensemble model. In one or more embodiments, machine learning model component 208 may utilize the training data from training dataset 206 that may be parsed, categorized, and/or labeled. Server system 106 may employ a Weighted Majority Rule Ensemble Classifier, one or more supervised machine learning techniques, and machine learning models, such as supervised learning models, unsupervised learning models, reinforcement learning models, and in particular Linear Regression, Linear Discriminant Analysis, Logistic Regression, Decision Tree, Naive Bayes, kNN, Support Vector Machines (SVM), Support Vector Classification, K-Means, Random Forest, and Dimensionality Reduction Algorithms. The machine learning model may work in tandem with various artificial intelligence techniques for example ranking, question-answering, and problem-solving tasks.

The rankings, classifications, and predictions made by the natural language processing model component 204 and/or machine learning model component 208 may be evaluated via one or more evaluation models, such as exact match (EM) (i.e., measures the percentage of predictions that match any one of the ground truth answers exactly), F1 (i.e., the weighted average of Precision and Recall), span-F1, and/or span-EM, which generate scores for each prediction. The F1 and EM metrics measure and evaluate, for example, the machine learning model component 208 performance related to properly classifying user responses (e.g., as funny or interesting and/or not funny or interesting). F1 may be calculated as follows:

$$F 1 = 2 \times \frac{Precision \times Recall}{Precision + Recall}$$

Wherein precision is the number of funny or interesting class predictions that in fact belong to the funny or interesting class, and recall is the number of funny or interesting class predictions made out of all funny or interesting responses in the overall responses.

EM may be determined by evaluating whether characters of the model's prediction exactly match the characters of one of the true answers. In the event that the characters of the prediction match the characters of the true answers, then EM=1; and if there a no matches, EM=0.

Notably, additional classification metrics may be utilized, such as accuracy (i.e., the number of all correct predictions), sensitivity/recall (i.e., true positive rate), and specificity (i.e., the true negative rate).

Further, the natural language processing model component 204 and/or machine learning model component 208 may be evaluated using a k-fold cross validation approach and the classification metrics. For example, Table 1 depicts typical classification results for a testing set using 5-fold cross validation for logistic regression classifier. Table 2 depicts typical classification results for a testing set using 5-fold cross validation for weighted majority voting classifiers. Accordingly, model performance may be improved by evaluating more than one classification metric, as training the natural language processing model component 204 and/or machine learning model component 208 has demonstrated that implementing the weighted majority voting classifiers yields better results compared to evaluating models based on singular classifiers (e.g., logistic regression classifier).

TABLE 1

| | Mean | Standard Deviation |
|---|---|---|
| Accuracy | .81 | .06 |
| Sensitivity | .67 | .14 |
| Specificity | .90 | .06 |
| Precision | .80 | .10 |
| F1 - Score | .72 | .11 |

TABLE 2

| | Mean | Standard Deviation |
|---|---|---|
| Accuracy | .88 | .05 |
| Sensitivity | .89 | .07 |
| Specificity | .88 | .06 |
| Precision | .88 | .05 |
| F1 - Score | .88 | .05 |

Framework 200 may additionally include trainer component 210 and pre-trained language model component 212. The trainer component 210 may be a training engine configured to loop over the training dataset and update model parameters. The trainer component 210 may receive the training dataset 206 and the pre-trained language model component 212 as input for one or more training models such as Bidirectional Encoder Representations from Transformers (BERT), Generative Pre-trained Transformer 2 (GPT2), and/or Robustly Optimized BERT Pre-training Approach (ROBERTA). The trainer component 210 may train and modify a language model implemented by the natural language processing model component 204 based on the aforementioned input, models and parameters.

Pre-trained language model component 212 may be a deep learning models (e.g., transformers) which are trained on the training dataset 206 to perform specific NLP tasks. By incorporating the pre-trained language model component 212, framework 200 may improve its accuracy and reduce the amount of training time required to complete NLP tasks. Pre-trained language model component 212 may include NLP models including but not limited to: Named Entity Recognition (NER), which is an NLP task where the model tries to identify the type of every word/phrase which appears in the input text; sentiment analysis, which is an NLP task where a model tries to identify if the given text has positive, negative, or neutral sentiment; machine translation is an NLP task where a model tries to translate sentences from one language into another; text summarization is an NLP task where a model tries to summarize the input text into a shorter version in an efficient way that preserves all important information from the input text; natural language generation is an NLP task where the model tries to generate natural language sentences from input data or information given by NLP developers; speech recognition is an NLP task where a model tries to identify what the user is saying; content moderation which is an NLP task where a model tries to identify the content which might be inappropriate (offensive/explicit), or should not be shown on public channels like social media posts, comments; and automated question answering (QA) systems: Automated QA systems try to answer user-defined questions automatically by looking at the input text.

Pre-trained language model component 212 may be trained to understand the grammatical and semantic structure of the corpus composed of user responses and engagement content. The pre-trained language model component 212 may be trained for days, weeks, or months to accurately understand the engagement/volunteer domain-specific language.

Framework 200 may additionally include engagement model component 214. Engagement model component 214 may be configured to receive the output from the natural language processing model component 204 and/or machine learning model component 208 and use it as input for various engagement opportunity tasks, such platform data population, engagement opportunity content creation, social media updates, matchmaking (e.g., users with users, and users with events), and recommending (e.g., recommendation user connections, engagement event opportunities, social media posts, invitations and/or user profile updates). The output from the engagement model component 214 may be used for one or more downstream tasks and internal/external devices (e.g., user device(s) 102.

Referring to FIG. 3, a computer-implemented method for using artificial intelligence (e.g., natural language processing and/or machine learning) to recommend and deliver an engagement opportunity 300 is depicted, according to the embodiments of the present disclosure. The method may be implemented within many different settings. For example, it may be used by a corporation or other organization to provide personalized, virtual volunteering opportunities for its employees, where the technology organizes the employees into various virtual volunteering groups with an electronic interface (the groups being positioned entirely virtual, or hybrid with a virtual and live assembly, e.g., where some employees assemble within a common live location and one or more others are positioned elsewhere and connect to the location by a computer and live video). This organization is based on common traits, preferences, or other rationales. In one aspect, such personalized organization of volunteering groups within an organization can more readily facilitate connections and relationships between employees than the employees could achieve through their own human networking efforts; the benefits of the technology can particularly improve employee performance and networking opportunities in a distributed work force.

More particularly, at step 302, server system 106 receives one or more user responses corresponding to one or more users, wherein the one or more user responses are associated with questions (e.g., a first set of causal. interesting, and/or frequency, questions and a second set of association, exploratory, and/or discovery questions) included in one or more electronic surveys. For example, users associated with an organization may have been transmitted one or more surveys including questions that can be used to gain insight regarding the users and their preferences in relation to social impact and other aspects. The questions may be used to gauge what type of causes the users are most passionate about (e.g., causes such as environment impact, social justice, homelessness, refugee care, civil issues, and the like) and further may be designed to illicit authentic positive emotions (e.g., love, joy, gratitude, serenity, interest, hope, pride, amusement, inspiration, awe, nostalgia, fear). The questions may additionally be related to casual details that inquire about the users' background (e.g., favorite sport, pet, vehicle, childhood memory), employment information, and/or demographical information. Accordingly, the user responses received by server system 106 may be varied. Notably, the user responses are configured in a digital format (e.g., text, audio, and/or image) that can be utilized by server system 106.

At step 304, server system 106 conveys the user responses to natural language model and/or a machine learning model as input for cleaning, analysis, and classification. The server system 106 processes the output of the model to determine one or more engagement events to recommend, and to construct customized content for a selected one or more of such events, as disclosed herein. In some applications, server system 106 classifies the users into one or more groups based on each user's corresponding responses to the surveys. In one embodiment, server system 106 may receive user responses to a set of questions as input for a k-mode clustering algorithm. Here, the k-mode clustering algorithm may group the user responses into categories or groups and responsively classify the users into one or more into groups based on the classification of their responses.

Similarly, at step 306, server system 106 classifies the one or more users into a second group and/or sub-group of the first group based on the user responses to the second set of questions.

At step 308, server system 106 recommends an engagement opportunity (e.g., a volunteering or other social impact opportunity) to each of the one or more users based on the second group and/or sub-group associated with each of the one or more users. For example, server system 106 may identify engagement opportunities that are of most interest to users based on the second group and/or sub-group that they are classified. In one non-limiting example, a user may be classified in a first main group for environmental activism and second group and/or sub-group of clean water initiatives. As a result, the server system 106 sends recommendations to the users classified in the clean water initiatives sub-group that prompt them to join events or meetups (virtual or in-person) that address this topic. The recommendation may then be received and accepted by the users. Notably, after accepting of such recommendation, the server system 106 conveys further details to the users regarding the engagement opportunity and provides a computer portal whereby one or more live or pre-recorded activities may be conducted with one or more users. For example, the engagement opportunity may include presentations and/or a live game (e.g., two truths and lie, guessing game, Pictionary®, multiple choice game, and the like), customized according to the results of the survey and prior examples, as developed by the artificial intelligence model, through methods and approaches disclosed herein. In the live game example, users may be encouraged to provide their responses at certain junctions throughout the game that can be captured by server system 106. The users may provide their event responses as text, an oratory response, and/or a selection of an option an interface.

At step 310 server system 106 initiates the engagement opportunity, wherein the content (e.g., the live or pre-recorded activities (or a combination thereof) presented in the engagement opportunity is generated based on the sub-group. For example, the server system 106 may host the engagement opportunity on a platform, website, virtual forum, and/or application configured to facilitate communication between one or more users and computing environment 100. In another example, the content of the engagement opportunity may be based on the user responses to the first set of questions discussed in relation to step 304. Here, the content may be customized to appeal to or illicit specific user sentiment or emotion based on the sentiment and/or emotion identified in the user responses.

The method then implements the event and adapts its content in a dynamic, real-time manner during the event. At 312, as discussed in relation to step 308, the users input user event responses through the interface that are then fed to server system 106. The server system 106 ranks or classifies each user event response via a natural language processing model (e.g., natural language processing model component 204) and/or machine learning model (e.g., machine learning model component 208). The natural language processing model component 204 and/or the machine learning model component 208 may rank and/or classify the user responses (e.g., according to relevance to a prompt in a game or presentation) during the engagement opportunity or based on previous responses provided by the user in a survey (e.g., users responses received at 302) or against other user responses. The user event responses may further be ranked based on a sentiment and semantic analysis of the content of the user event responses. For example, server system 106 may be configured to identify tone associated with a user event response, such as whether a user's user event response was funny or not funny Notably, other tones may be gleaned, such as whether the user event response indicates a tone of happy, sad, and/or satisfaction. The tones are then processed by the server system 106 to train the natural language model, as described herein. In one example user event responses may be assigned a sentiment score as discussed in relation to framework 200 and thereby relative to one or more of training data, previous user responses, or content in the game, which may be composed of words or phrases that have been assigned sentiment scores.

Once the user event responses have been ranked and/or classified, the rank and/or classification of each user's user event response are used to generate (or modify) content for the engagement opportunity in real-time. For example, server system 106 may modify the content presented during a game or presentation on-the-fly (i.e., in real-time) based on user event responses. In one instance, server system 106 may determine that one or more user's sentiment indicates satisfaction with game or presentation, and in response, modify the content (e.g., a script and/or question(s)) to present additional content that is likely to increase user satisfaction. In some implementations, the server system 106 may assess the user ranks and/or classifications from multiple users and generate an overall sentiment analysis that is then used by the system to modify the content. In addition to real-time use cases, in some instances, user event responses may be used for one or more downstream purposes, such as matching users with future engagement opportunities, connecting users with other users, and the like. For example, user event responses may be received as input, ranked and analyzed as discussed above at 312, and leveraged by natural language processing model (e.g., natural language processing model component 204) and/or machine learning model (e.g., machine learning model component 208) to match users with future engagements.

In addition, server system 106 may infer that one or more users are present and participating in the engagement opportunity based on the fact that the one or more users answer questions, are visible to the host of the engagement opportunity (i.e., their camera is on and therefore can be seen), and/or the fact that the user logged in with credentials (e.g., user name, password, or link). Server system 106 may be configured to aggregate user data by one or more of: detecting/tracking the number of cameras that are on during an engagement opportunity and user biometric data, implementing voice recognition, reading facial expressions of users (e.g., through the camera), determining user frequency of speech, determining user chat frequency, conducting content analysis on user chat or speech, determining tone of verbal/written communication, detecting user language patterns, and click sequence data. Language pattern analysis can include assessment of words and phrases used by the user in speech during the event or in the chat and can be used to identify words or phrases indicative of, for example, humor. Such pattern analysis can include one or more of, for example, assessment of repetition of terms, juxtaposition of terms, or use of metaphors or terms that have a pre-determined characterization (e.g., words or phrases that have been identified previously as being indicative of humor), and other features identified herein. Server system 106 may be configured to extract from the analysis terms used by the users (or other outputs of the user data analysis, e.g., as indicated above) and modify the content of the engagement opportunity in real-time based on the users that are present, user participation in the engagement opportunity, and/or based on the aggregated user data.

Further, server system 106 may be configured to analyze various data regarding the one or more users (e.g., user employee ID, user participation history/frequency information, user profile information and/or user demographic information) and modify the content of the engagement in real-time based on this information.

At 314, server system 106 may receive feedback from the one or more users. For example, server system 106 may receive feedback from the one or more user regarding an engagement opportunity that they participated in. The feedback may indicate the one or more user's critique of the knowledge that was deiminated during the engagement opportunity, how entertaining the engagement opportunity was, insight as to how the engagement opportunity can be improved, and insight as to whether the one or more users would participate in the engagement opportunity again, and the like.

At 316, server system 106 may fine-tune the natural language processing model based on the feedback from the one or more users. For example, server system 106 may leverage the feedback from the one or more user as input for the trainer component 210 in order to fine-tune both the natural language processing model and machine learning model based. In some instances, fine tuning may include training the entire natural language processing model and machine learning model based on a new/modified dataset. Here, the error is back-propagated through the entire architecture and the pre-trained weights of the model are updated based on the new dataset.

In another instance, fine tuning may include layer-freezing, the natural language processing and machine learning models. For example, the initial parameters and weights in some of the layers of the natural language processing and machine learning model can be kept the same (i.e., frozen), while other layers can be retrained. Experimentation can be done to test how many layers need to be frozen and how many need to be retrained.

In another instance, fine tuning the natural language processing model and machine learning model may include taking a layer-wise learning rate approach, wherein the natural language processing model and machine learning model may have one or more hyperparameters (i.e., learning rates) for one or more layers within the model modified. Here, the learning rate is a hyperparameter that controls how much to change the model in response to the estimated error each time the model weights are updated. As such, the learning rate controls how quickly the natural language processing model and machine learning model adapt to the task-specific problem.

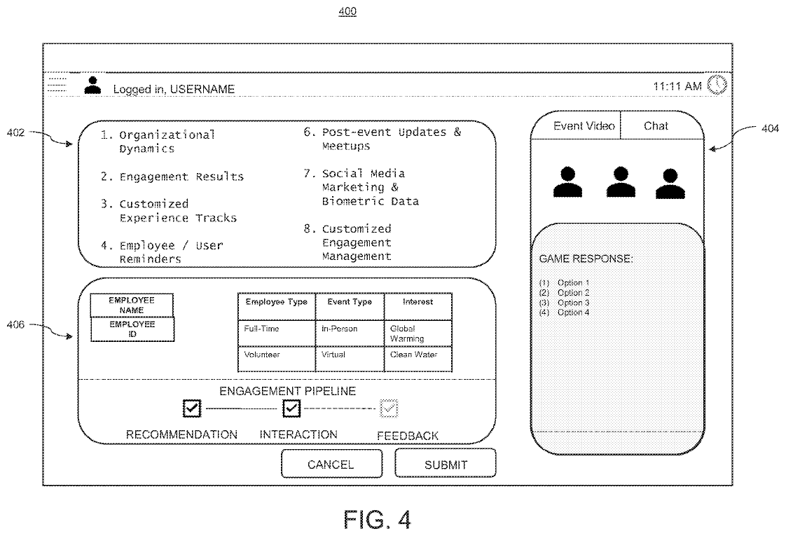

Referring to FIG. 4, an interactive graphical user interface is depicted, according to various embodiments of the present disclosure. In some instances, the interactive GUI 400 may be a stand-alone application, or a sub-feature associated within a software product (e.g., a platform, dashboard and/or website). The interactive GUI 400 may be operated by one or more users using one or more user device(s) 102 and/or one or more users of agent device(s) 104. In some embodiments, interactive GUI 400 initiates and plays an integral role for processes associated with training a natural language processing model (implemented by natural language processing model component 204) or a machine learning model (implemented by machine learning model component 208) referenced in and/or a method for providing recommendations or additional information to a user as briefly discussed with respect to FIGS. 2-3. As depicted in FIG. 4, interactive GUI 400 includes several dynamic features for automatically organizing, generating, and conducting an engagement opportunity, matchmaking, and providing recommendations. In the illustrated example, interactive GUI 400 includes a user menu region 402, automated intelligent communication region 404, and dynamic results region 406.

As depicted in user menu region 402, a series of user options may be populated in response to the type of action being performed by a user, whether the user is associated with a client and/or whether the user is associated with an organization operating computing environment 100. User menu region 402 may additionally be populated with various option based on inputs or changes to automated intelligent communication region 404, and dynamic results region 406. User menu region 402 may include options for managing organization dynamics, employee results, customized experience tracks, employee/user reminders, post-event updates and meetups, social media marketing, biometric data, customized engagement management. User menu region 402 may permit users to update their profile information, upload documents, and input user preferences/settings. For example, user menu region 402 may permit users to upload human resource (HR) documents regarding one or more users. Such documents may be aggregated and used for downstream tasks such as matchmaking. User menu region 402 may enable users to engage in user-to-user matchmaking and linking and interaction with social media marketing accounts.

Automated intelligent communication region 404 may enable a user to communicate with computing environment 100, one or more users, and/or automated assistants. In particular, automated intelligent communication region 404 may enable a user to conduct video, audio, or chat/text communication. For example, a user may leverage automated intelligent communication region 404 to participate in a live engagement opportunity (e.g., a presentation, volunteer event, or game) virtual via video with the user device(s) and its corresponding camera. Users may additionally leverage automated intelligent communication region 404 to submit user event responses; for example, user event responses associated with game. In addition, users may leverage automated intelligent communication region 404 to provide feedback associated with an engagement opportunity. Automated intelligent communication region 404 may additionally enable users to post social media posts and make comments on social media feeds. Automated intelligent communication region 404 may use an additional server as a tool for visually depicted how one or more users have been classified into groups and sub-groups.

Dynamic results region 406 may dynamically populate with relevant editable information and tools, in response to the type of activity the user is engaged in. For example, in response to the user selecting an option from the presented in user menu region 402, dynamic results region 406 may dynamically populate with relevant details regarding the option that was selected. In addition, or alternatively, dynamic results region 406 populates the information related to a going engagement opportunity and/or displays information indicative of user progress along a user experience track. Dynamic results region 406 may enable and/or prompt a user to add relevant information displayed therein to a user's profile or to a specific field. Dynamic results region 406 additionally allows a user to modify certain scripts, code, and content associated with implementing an engagement opportunity. As such, dynamic results region 406 may serve as an integrated development environment. Moreover, dynamic results region 406 may serve as notification region wherein recommendations are presented to a user. For example, users may receive recommendations as to which type of engagement opportunities they should participate in, in dynamic results region 406. Notably, while making recommendations have been discussed relative to users, it should be understood that recommendations can be made to companies/organizations.

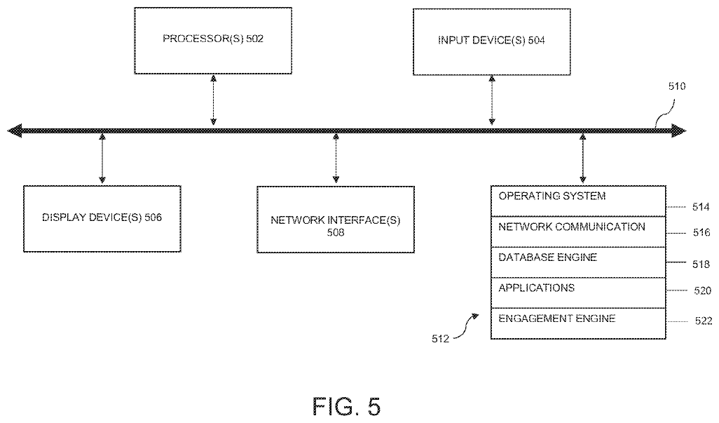

Referring to FIG. 5, a block diagram for a computing device, according to various embodiments of the present disclosure. The computing device 500 may be implemented on any electronic device that runs software applications derived from compiled instructions, including without limitation personal computers, servers, smart phones, media players, electronic tablets, game consoles, email devices, etc. In some implementations, the computing device 500 may include processor(s) 502, (one or more) input device(s) 504, one or more display device(s) 506, one or more network interfaces 508, and one or more computer-readable medium(s) 512 storing software instructions. Each of these components may be coupled by bus 510, and in some embodiments, these components may be distributed among multiple physical locations and coupled by a network 110.

Display device(s) 506 may be any known display technology, including but not limited to display devices using Liquid Crystal Display (LCD) or Light Emitting Diode (LED) technology. Processor(s) 502 may use any known processor technology, including but not limited to graphics processors and multi-core processors. Input device(s) 504 may be any known input device technology, including but not limited to a keyboard (including a virtual keyboard), mouse, track ball, camera, and touch-sensitive pad or display. Bus 510 may be any known internal or external bus technology, including but not limited to ISA, EISA, PCI, PCI Express, USB, Serial ATA or FireWire. Computer-readable medium(s) 512 may be any non-transitory medium that participates in providing instructions to processor(s) 502 for execution, including without limitation, non-volatile storage media (e.g., optical disks, magnetic disks, flash drives, etc.), or volatile media (e.g., SDRAM, ROM, etc.).

Computer-readable medium(s) 512 may include various instructions for implementing an operating system 514 (e.g., Mac OS®, Windows®, Linux). The operating system may be multi-user, multiprocessing, multitasking. multithreading, real-time, and the like. The operating system may perform basic tasks, including but not limited to: recognizing input from input device(s) 504; sending output to display device(s) 506; keeping track of files and directories on computer-readable medium(s) 512; controlling peripheral devices (e.g., disk drives, printers, etc.) which can be controlled directly or through an I/O controller; and managing traffic on bus 510. Network communications instructions 516 may establish and maintain network connections (e.g., software for implementing communication protocols, such as TCP/IP, HTTP, Ethernet, telephony, etc.).

Database processing engine 518 may include instructions that enable computing device 500 to implement one or more methods as described herein. Application(s) 520 may be an application that uses or implements the processes described herein and/or other processes. The processes may also be implemented in operating system 514. For example, application(s) 520 and/or operating system 514 may execute one or more operations to intelligently process text/video/audio data (i.e., user responses) via one or more natural language processing and/or machine learning algorithms.

Engagement engine 522 may be used in conjunction with one or more methods as described above. Receive text/video/audio data (i.e., user responses) at computing device 500, which may then be fed into engagement engine 522 to analyzing and classify the text/video/audio data and provide information and suggestions about the text/video/audio data to a user in real-time.

The described features may be implemented in one or more computer programs that may be executable on a programmable system including at least one programmable processor coupled to receive data and instructions from, and to transmit data and instructions to a data storage system (e.g., database(s) 108), at least one input device, and at least one output device. A computer program is a set of instructions that can be used, directly or indirectly, in a computer to perform a certain activity or bring about a certain result. A computer program may be written in any form of programming language (e.g., Janusgraph, Gremlin, Sandbox, SQL, Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, which provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

It is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

What is claimed is:

1. A system comprising:
a server comprising one or more processors; and
a non-transitory memory, in communication with the server, storing instructions that when executed by the one or more processors, causes the one or more processors to implement a method comprising:
receiving by an plurality of electronic interfaces, a plurality of user responses corresponding to a plurality of users, wherein the user responses are associated with a first set of questions and a second set of questions included in one or more surveys;
classifying the plurality of users into a first group based on the user responses to the first set of questions;
classifying the users of the first group into a second group based on the user responses to the second set of questions;
storing digital information indicative of an association between the second group and a plurality of engagement opportunities in an electronic database, wherein each of the plurality of engagement opportunities is configured to present electronic content for engagement by one or more of the plurality of users;
selecting, through an electronic interface, an engagement opportunity from the plurality of engagement opportunities based on the second group;
recommending, through the electronic interfaces, the selected engagement opportunity to each of the plurality of users;
initiating, through the electronic interfaces, the selected engagement opportunity, wherein first electronic content presented in the engagement opportunity is generated based on the second group;
receiving user event responses electronically during the engagement opportunity;
inputting the received user event responses into a natural language processing model;
ranking, by the natural language processing model, the user event responses;
generating second electronic content responsive to the ranked user event responses;
modifying the first electronic content of the engagement opportunity to include the second electronic content;
presenting the modified first electronic content through the plurality of electronic interfaces;
receiving feedback from the one or more users; and
training the natural language processing model based on the feedback from the one or more users.

2. The system of claim 1, further comprising:
tokenizing the plurality of user responses; and
determining an importance of each word using a term frequency inverse document frequency model.

3. The system of claims 1, wherein a machine learning model further classifies the user event responses.

4. The system of claim 1, further comprising identifying engagement opportunities to one or more users based on the second group where the one or more users are classified.

5. The system of claim 1, further comprising:
determining, by the natural language processing model, user sentiment in real-time based on the user event responses; and
responsive to the determining, generating new content for the engagement opportunity in real-time.

6. The system of claim 1, wherein training the natural language processing model based on the feedback from the users further comprises fine tuning and updating pre-trained weights of the natural language processing model.

7. The system of claim 1, wherein performance of a machine learning model related to properly classifying the user responses is evaluated using exact match.

8. A computer-implemented method comprising:
receiving a plurality of user responses corresponding to a plurality of users, wherein the plurality of user responses are associated with a first set of questions and a second set of questions included in one or more surveys;
classifying the plurality of users into a first group based on the user responses to the first set of questions;
classifying the users of the first group into a sub-group of the first group based on the user responses to the second set of questions;
recommending an engagement opportunity to each of the plurality of users based on the respective sub-group into which the users are classified;
initiating the engagement opportunity, wherein first electronic content presented in the engagement opportunity is generated based on the sub-group;
inputting user event responses into a natural language processing model;
ranking, by the natural language processing model, the user event responses;
generating second electronic content responsive to the ranked user event responses;
modifying the first electronic content of the engagement opportunity to include the second electronic content;
presenting the modified first electronic content;
receiving feedback from the users; and
training the natural language processing model based on the feedback from the users.

9. The computer-implemented method of claim 8, further comprising:
tokenizing the user responses; and
determining an importance of each word using a term frequency inverse document frequency model.

10. The computer-implemented method of claim 8, wherein a machine learning model further classifies the user event responses.

11. The computer-implemented method of any of claims 8, further comprising identifying engagement opportunities to users based on the sub-group where the one or more users are classified.

12. The computer-implemented method of claim 8, further comprising:
determining, by the natural language processing model, user sentiment in real-time based on the user event responses; and
responsive to the determining, generating new content for the engagement opportunity in real-time.

13. The computer-implemented method of claim 8, wherein training the natural language processing model based on the feedback from the users further comprises fine tuning and updating pre-trained weights of the natural language processing model.

14. The computer-implemented method of claim 8, wherein performance of a machine learning model related to properly classifying the user responses is evaluated using exact match.

15. A non-transitory computer-readable medium storing instructions, that when executed by one or more processors, cause the one or more processors to implement the instructions for:
receiving a plurality of responses corresponding to a plurality of users, wherein the one or more user responses are associated with a first set of questions and a second set of questions included in one or more surveys;
classifying the plurality of users into a first group based on the user responses to the first set of questions;
classifying the users of the first group into a sub-group of the first group based on the user responses to the second set of questions;
recommending an engagement opportunity to each of the plurality of users based on the respective sub-group into which the users are classified;
initiating the engagement opportunity, wherein first electronic content presented in the engagement opportunity is generated based on the sub-group;
inputting user event responses into a natural language processing model, wherein the user event responses are ranked and used to select user responses indicating one or more of: a pre-determined sentiment, a user match, or a winner of a game;
ranking, by the natural language processing model, the user event responses;
generating second electronic content responsive to the ranked user event responses;
modifying the first electronic content of the engagement opportunity to include the second electronic content;
presenting the modified first electronic content;
receiving feedback from the plurality of users; and
training the natural language processing model based on the feedback from the plurality of users.

16. The non-transitory computer-readable medium of claim 15, further comprising:
tokenizing the user responses; and
determining an importance of each word using a term frequency inverse document frequency model.

17. The non-transitory computer-readable medium of claim 15, wherein a machine learning model further classifies the user event responses.

18. The non-transitory computer-readable medium of claim 15, further comprising identifying engagement opportunities to users based on the sub-group where the users are classified.

19. The non-transitory computer-readable medium of claim 15, further comprising:
determining, by the natural language processing model, user sentiment in real-time based on the user event responses; and
responsive to the determining, generating new content for the engagement opportunity in real-time.

20. The non-transitory computer-readable medium of claim 15, wherein training the natural language processing model based on the feedback from the plurality of users further comprises fine tuning and updating pre-trained weights of the natural language processing model.

21-47. (canceled)
